(19) United States
(12) Patent Application Publication
(10) Pub. No.: US 2014/0010155 A1
(43) Pub. Date: Jan. 9, 2014

(54) MARITIME BROADBAND MOBILE COMMUNICATION APPARATUS AND COMMUNICATION METHOD USING THE SAME

(71) Applicant: Electronics and Telecommunications Research Institute, Daejeon-city (KR)

(72) Inventor: Jae-Myoung KIM, Daejeon (KR)

(21) Appl. No.: 13/927,300

(22) Filed: Jun. 26, 2013

(30) Foreign Application Priority Data
Jul. 4, 2012 (KR) 10-2012-0072601

(51) Int. Cl. H04W 40/20

(52) U.S. Cl. CPC H04W 40/20
USPC 370/328

(57) ABSTRACT

Disclosed herein are a maritime broadband mobile communication apparatus and a communication method using the apparatus. The communication method is configured such that a broadband mobile communication apparatus located in a vessel and provided with an intra-vessel communication processing unit, a satellite communication processing unit, and a broadband wireless communication processing unit communicates with another vessel or a ground base station. A communication target is identified based on AIS information collected via an AIS located on land. A communication direction corresponding to the communication target is determined. The intra-vessel communication processing unit, the satellite communication processing unit, and the broadband wireless communication processing unit are switched depending on the communication direction, and a direction of a broadband mobile communication antenna is controlled in response to results of the switching. The apparatus communicates with the other vessel or the ground base station using the broadband mobile communication antenna.

### CROSS REFERENCE TO RELATED APPLICATION

This application claims the benefit of Korean Patent Application No. 10-2012-0072601, filed on Jul. 4, 2012, which is hereby incorporated by reference in its entirety into this application.

### BACKGROUND OF THE INVENTION

1. Technical Field

The present invention relates generally to a maritime broadband mobile communication apparatus and a communication method using the apparatus. More particularly, the present invention relates to an apparatus that performs broadband mobile communication between vessels at sea and between each vessel and a ground base station by controlling a broadband mobile communication antenna based on the automatic identification system information and the status of each vessel, and to a communication method using the apparatus.

2. Description of the Related Art

Land mobile broadband communication supports services on the outskirts of a downtown area by installing repeater base stations or using beamforming technology for antennas Further, land mobile broadband communication enables long-range broadband data transmission to be performed by applying mesh network technology to next-generation Wireless Local Area Network (WLAN) technology.

Although maritime broadband mobile communication has been able to provide services by extending the use of expensive satellite communication or special-purpose land mobile broadband communication, such as WLAN Access Points (APs) installed near a port or maritime Wibro, it is problematic in that communication is possible only within an extremely limited range due to the limited coverage of radio waves.

### SUMMARY OF THE INVENTION

Accordingly, the present invention has been made keeping in mind the above problems occurring in the prior art, and an object of the present invention is to provide a maritime broadband mobile communication apparatus and a communication method using the apparatus, which perform broadband mobile communication between vessels at sea and between each vessel and a ground base station by controlling a broadband mobile communication antenna based on the Automatic Identification System (AIS) information and the status of each vessel.

In accordance with an aspect of the present invention to accomplish the above object, there is provided a communication method, the method being configured such that a broadband mobile communication apparatus located in a vessel and provided with an intra-vessel communication processing unit, a satellite communication processing unit, and a broadband wireless communication processing unit communicates with some other vessel or a ground base station, the method including identifying a communication target based on Automatic Identification System (AIS) information collected via an AIS located on land; determining a communication direction corresponding to the identified communication target; switching the intra-vessel communication processing unit, the satellite communication processing unit, and the broadband wireless communication processing unit depending on the determined communication direction, and controlling a direction of a broadband mobile communication antenna in response to results of the switching; and communicating with the other vessel or the ground base station using the broadband mobile communication antenna.

Preferably, the broadband mobile communication antenna may correspond to a dual antenna having two antenna elements, which face in opposite directions and the directions of which can be adjusted at an angle of 180° (hereinafter referred to as a “dual antenna”).

Preferably, the AIS information may correspond to information including a unique identification (ID), a location, and a velocity of each of a plurality of vessels located at sea.

In accordance with another aspect of the present invention to accomplish the above object, there is provided a maritime broadband mobile communication apparatus, the apparatus being located in a vessel at sea and performing broadband mobile communication, including an intra-vessel communication processing unit for processing communication between pieces of intra-vessel equipment using an internal network of the vessel;

a satellite communication processing unit for performing communication with a satellite communication device; a broadband wireless communication processing unit for performing communication with a broadband mobile communication antenna; a communication target identification unit for identifying a communication target based on Automatic Identification System (AIS) information; a direction recognition unit for determining a communication direction corresponding to the communication target; and a switching gateway for switching the intra-vessel communication processing unit, the satellite communication processing unit, and the broadband wireless communication processing unit depending on the communication direction, and controlling a direction of the broadband mobile communication antenna in response to results of the switching, wherein the apparatus communicates with some other vessel or a ground base station using the broadband mobile communication antenna.

Preferably, the broadband mobile communication antenna may correspond to a dual antenna having two antenna elements which face in opposite directions and the directions of which can be adjusted at an angle of 180°.

Preferably, the AIS information may correspond to information including a unique identification (ID), a location, and a velocity of each of a plurality of vessels located at sea.

Preferably, the switching gateway may transfer a control signal required to control the direction of the broadband mobile communication antenna to an antenna steering device in response to the results of the switching, thus allowing the antenna steering device to control the direction of the broadband mobile communication antenna.

Accordingly, the present invention can control the broadband mobile communication antenna based on the AIS information and the status of each vessel, thus performing broadband mobile communication between vessels at sea and between each vessel and a ground base station.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically showing an environment to which a maritime broadband mobile communication apparatus is applied according to an embodiment of the present invention;

FIG. 2 is a configuration diagram showing a maritime broadband mobile communication apparatus according to an embodiment of the present invention; and

FIG. 3 is a flowchart showing a communication method using the maritime broadband mobile communication apparatus according to an embodiment of the present invention.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

Hereinafter, a maritime broadband mobile communication apparatus and a communication method using the apparatus according to embodiments of the present invention will be described in detail with reference to the attached drawings.

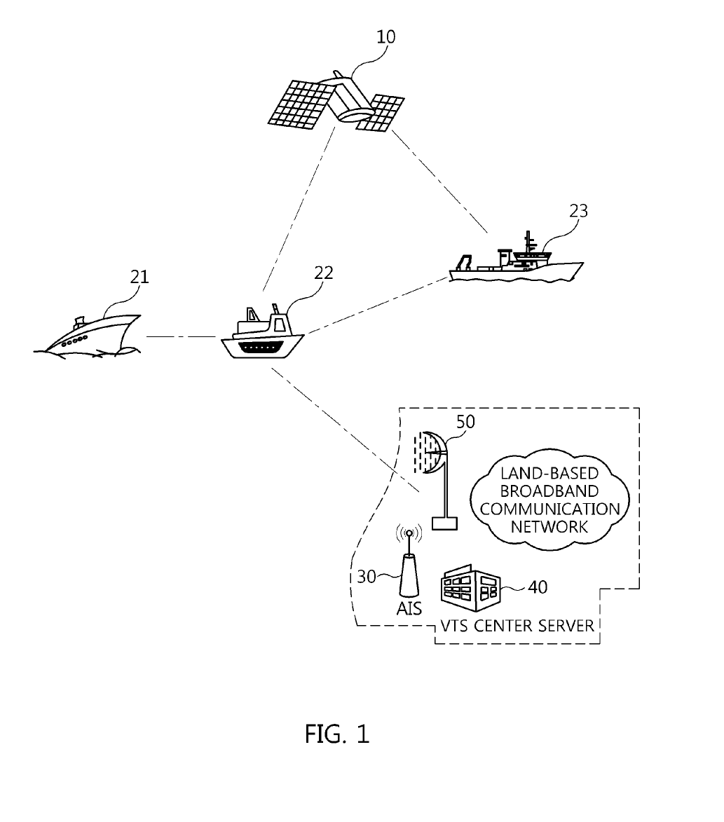

FIG. 1 is a diagram schematically showing an environment to which a maritime broadband mobile communication apparatus is applied according to an embodiment of the present invention.

Referring to FIG. 1, the environment to which the maritime broadband mobile communication apparatus is applied according to the embodiment of the present invention includes a satellite communication device 10, a plurality of vessels 21 to 23, an automatic identification system (hereinafter referred to as an “AIS”) 30, a vessel traffic service (hereinafter referred to as “VTS”) center server 40, and a broadband mobile communication antenna 50.

The satellite communication device 10 corresponds to an Inmarsat-C or a Very Small Aperture Terminal (VSAT).

Each of the plurality of vessels 21 to 23 includes a broadband mobile communication apparatus, and performs communication with other vessels or broadband mobile communication with the AIS 30 on the basis of the broadband mobile communication apparatus.

The AIS 30 corresponds to a ground base station, and collects and processes pieces of automatic identification system information (hereinafter referred to as “AIS information”) of respective vessels at sea. Here, the AIS information includes information such as the unique identification (BD), location, velocity, etc. of the corresponding vessel.

The VTS center server 40 controls maritime traffic based on the plurality of vessels 21 to 23 and AIS information corresponding thereto.

The broadband mobile communication antenna 50 is located on land, and the transmission/reception directions thereof are adjusted under the control of the broadband mobile communication apparatus in response to the AIS information and the status of each vessel.

For example, a communication apparatus in the first vessel 21 being unable to perform broadband mobile communication is operated in conjunction with a broadband mobile communication apparatus in the second vessel 22 being able to communicate with a ground base station, that is, the AIS 30, and is then capable of performing broadband mobile communication.

Further, the broadband mobile communication apparatus in the second vessel 22 provides a mesh network function, and is operated in conjunction with the satellite communication device 10 and the communication apparatus in the third vessel 23 being able to communicate with the AIS 30, thus enabling broadband mobile communication to be performed.

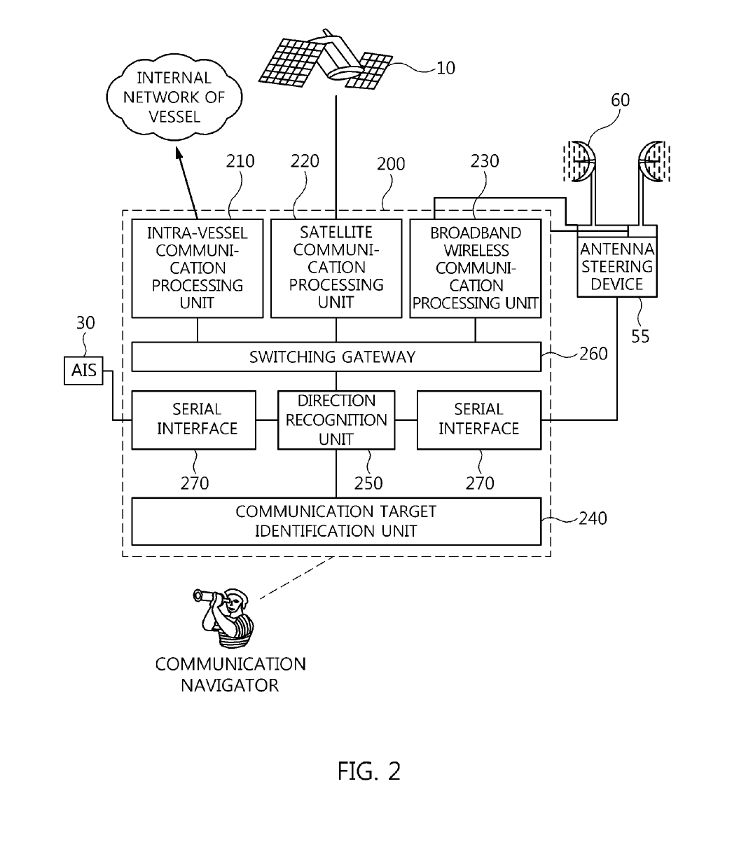

Below, the broadband mobile communication apparatus in the second vessel 22 will be described in detail with reference to FIG. 2.

FIG. 2 is a configuration diagram showing the maritime broadband mobile communication apparatus according to an embodiment of the present invention.

Referring to FIG. 2, a broadband mobile communication apparatus 200 includes an intra-vessel communication processing unit 210, a satellite communication processing unit 220, a broadband wireless communication processing unit 230, a communication target determination unit 240, a direction recognition unit 250, a switching gateway 260, and serial interfaces 270.

The intra-vessel communication processing unit 210 processes communication between pieces of intra-vessel equipment using the internal network of the corresponding vessel.

The satellite communication processing unit 220 performs communication with the satellite communication device 10.

The broadband wireless communication processing unit 230 performs broadband wireless communication while communicating with a dual antenna 60. Here, the dual antenna 60 according to an embodiment of the present invention is a broadband mobile communication antenna for performing broadband mobile communication, and includes an antenna steering device 55 for controlling the dual antenna. The dual antenna 60 has a directivity of 180° for each antenna element.

The communication target identification unit 240 collects AIS information via the AIS 30 or a communication navigator, and identifies a communication target based on the collected AIS information. In this case, the communication target identification unit 240 performs serial communication with the AIS 30 via the serial interfaces 270.

The direction recognition unit 250 determines a communication direction corresponding to the results of the identification by the communication target identification unit 240, that is, a communication target.

The switching gateway 260 switches the intra-vessel communication processing unit 210, the satellite communication processing unit 220, and the broadband wireless communication processing unit 230 depending on the communication direction determined by the direction recognition unit 250. The switching gateway 260 transfers a control signal required to control the direction of the dual antenna 60 to the antenna steering device 55 in response to the results of the switching

Then, the antenna steering device 55 controls the direction of the dual antenna 60 in response to the control signal, so that the broadband mobile communication apparatus 200 can perform broadband mobile communication via the dual antenna 60.

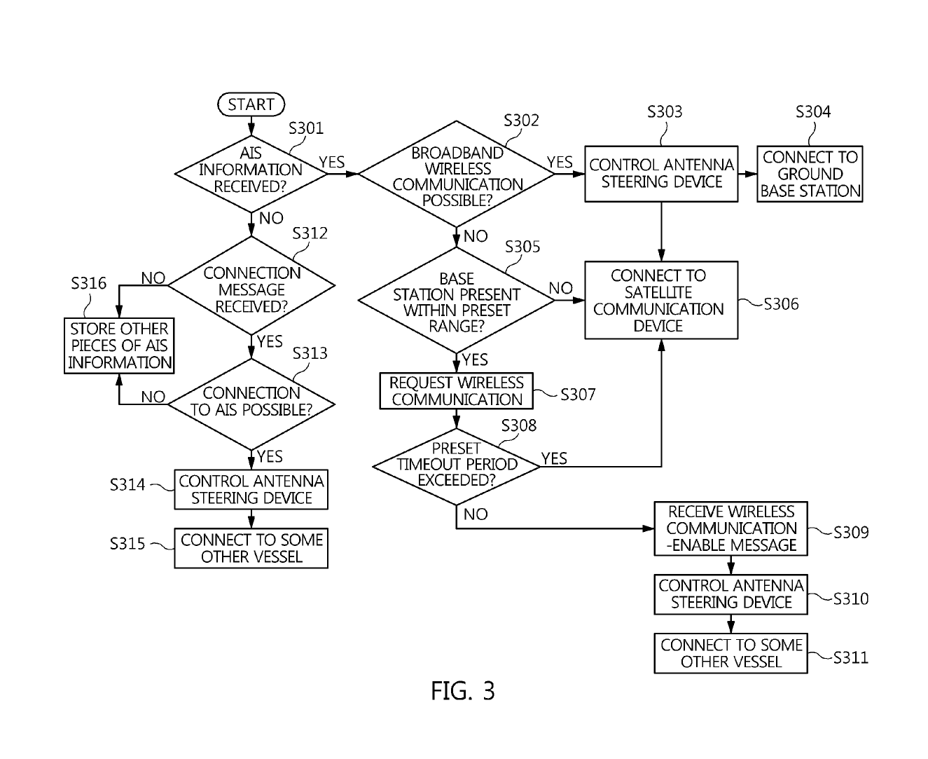

Below, a communication method using the maritime broadband mobile communication apparatus will be described in detail with reference to FIG. 3.

FIG. 3 is a flowchart showing a communication method using the maritime broadband mobile communication apparatus according to an embodiment of the present invention.

Referring to FIG. 3, the broadband mobile communication apparatus 200 receives an AIS message and determines whether AIS information is included in the AIS message, via the AIS 30 or the communication navigator at step S301. Here, the AIS information is information obtained by automatically identifying a plurality of vessels at sea, and includes the unique ID, location, velocity, etc. of each vessel.

If the AIS information is received, the broadband mobile communication apparatus 200 determines whether broadband wireless communication with a ground base station (for example, the AIS 30) is possible at step S302.

The broadband mobile communication apparatus 200 determines a communication direction corresponding to the ground base station if it is determined that baseband wireless communication with the ground base station is possible, and controls the antenna steering device 55 depending on the determined communication direction at step S303. That is, the antenna steering device 55 controls the dual antenna 60 depending on the determined communication direction. The broadband mobile communication apparatus 200 establishes a connection with the ground base station using the dual antenna 60 at step S304.

The broadband mobile communication apparatus 200 determines whether some other base station is present within a preset range if it is determined that baseband wireless communication with the ground base station is impossible at step S305.

The broadband mobile communication apparatus 200 establishes a connection with the satellite communication device 10 if some other base station is not present within the preset range at step S306. In detail, if some other base station is not present within the preset range, the broadband mobile communication apparatus 200 determines a communication direction corresponding to the satellite communication device 10 based on the AIS information, and switches the satellite communication processing unit 220 depending on the determined communication direction, thus establishing a connection with the satellite communication device 10.

If some other base station is present within the preset range, the broadband mobile communication apparatus 200 requests wireless communication from the other base station at step S307. The broadband mobile communication apparatus 200 determines whether a wireless communication-enable message has been received during a timeout period preset after the time point at which wireless communication was requested at step S308.

The broadband mobile communication apparatus 200 establishes a connection with the satellite communication device 10 if a wireless communication-enable message has not been received during the preset timeout period.

The broadband mobile communication apparatus 200 receives the wireless communication-enable message during the preset timeout period at step S309, and controls the antenna steering device 55 in response to the wireless communication-enable message at step S310. The broadband mobile communication apparatus 200 performs communication with some other vessel via communication with the dual antenna 60, the direction of which has been adjusted by the antenna steering device 55, at step S311.

If the AIS message has been received at step S301 and AIS information is not included in the AIS message, the broadband mobile communication apparatus 200 determines whether a connection message has been received from the AIS 30 at step S312.

If the connection message has been received, the broadband mobile communication apparatus 200 determines whether its own vessel can be connected to the AIS 30, on the basis of the received connection message at step S313. The broadband mobile communication apparatus 200 controls the antenna steering device 55 depending on the communication direction corresponding to the AIS 30 if its own vessel can be connected to the AIS 30 at step S314. Therefore, the antenna steering device 55 controls the dual antenna 60 depending on the communication direction corresponding to the AIS 30. The broadband mobile communication apparatus 200 establishes a connection with some other vessel using the dual antenna 60 at step S315.

If it is determined at step S312 that a connection message has not been received or if it is determined at step S313 that a connection between its own vessel and the AIS 30 is impossible, the broadband mobile communication apparatus 200 separately stores other pieces of AIS information in the AIS message at step S316.

As described above, the present invention controls the broadband mobile communication antenna based on the AIS information and the status of each vessel, thus performing broadband mobile communication between vessels at sea and between each vessel and a ground base station.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A communication method, the method being configured such that a broadband mobile communication apparatus located in a vessel and provided with an intra-vessel communication processing unit, a satellite communication processing unit, and a broadband wireless communication processing unit communicates with some other vessel or a ground base station, the method comprising:
identifying a communication target based on Automatic Identification System (AIS) information collected via an AIS located on land;
determining a communication direction corresponding to the identified communication target;
switching the intra-vessel communication processing unit, the satellite communication processing unit, and the broadband wireless communication processing unit depending on the determined communication direction, and controlling a direction of a broadband mobile communication antenna in response to results of the switching; and
communicating with the other vessel or the ground base station using the broadband mobile communication antenna.

2. The communication method of claim 1, wherein the broadband mobile communication antenna corresponds to a dual antenna.

3. The communication method of claim 1, wherein the AIS information is information including a unique identification (ID), a location, and a velocity of each of a plurality of vessels located at sea.

4. A maritime broadband mobile communication apparatus, the apparatus being located in a vessel at sea and performing broadband mobile communication, comprising:
an intra-vessel communication processing unit for processing communication between pieces of intra-vessel equipment using an internal network of the vessel;
a satellite communication processing unit for performing communication with a satellite communication device;
a broadband wireless communication processing unit for performing communication with a broadband mobile communication antenna;
a communication target identification unit for identifying a communication target based on Automatic Identification System (AIS) information;
a direction recognition unit for determining a communication direction corresponding to the communication target; and
a switching gateway for switching the intra-vessel communication processing unit, the satellite communication processing unit, and the broadband wireless communication processing unit depending on the communication direction, and controlling a direction of the broadband mobile communication antenna in response to results of the switching,
wherein the apparatus communicates with some other vessel or a ground base station using the broadband mobile communication antenna.

5. The maritime broadband mobile communication apparatus of claim 4, wherein the broadband mobile communication antenna corresponds to a dual antenna.

6. The maritime broadband mobile communication apparatus of claim 4, wherein the AIS information is information including a unique identification (ID), a location, and a velocity of each of a plurality of vessels located at sea.

7. The maritime broadband mobile communication apparatus of claim 4, wherein the switching gateway transfers a control signal required to control the direction of the broadband mobile communication antenna to an antenna steering device in response to the results of the switching, thus allowing the antenna steering device to control the direction of the broadband mobile communication antenna.
